(19) United States
(12) Patent Application Publication
(10) Pub. No.: US 2019/0059076 A1
(43) Pub. Date: Feb. 21, 2019

(54) Transceiver, methods and computer program for radio resource distribution

(71) Applicant: Techische Universitaet Ilmenau, Ilmenau (DE)

(72) Inventors: André Puschmann, Erfurt (DE); Dariush M. Soleymani, Ilmenau (DE); Andreas Mitschele-Thiel, Ilmenau (DE); Elke Roth-Mandutz, Nuernberg (DE); Jens Mueckenheim, Merseburg (DE)

(21) Appl. No.: 16/078,647

(22) PCT Filed: Feb. 20, 2017
(86) PCT No.: PCT/EP2017/053817

§ 371 Date: Aug. 22, 2018

(30) Foreign Application Priority Data
Feb. 22, 2016 (DE) 10 2016 103 027.9

(51) Int. Cl. H04W 72/04; H04L 12/911; H04W 4/06; H04W 4/70; H04W 72/12

(52) U.S. Cl. CPC H04W 72/04; H04L 47/828; H04W 72/1268; H04W 4/70; H04W 4/06

(57) ABSTRACT

Embodiments include transceivers, methods and computer programs for radio resource distribution. In a mobile communication system a first transceiver determines information on previously allocated but non-required radio resources and a second transceiver uses these non-required radio resources for transmitting own data. A base station transceiver 300 allocates a group of radio resources to a first transceiver and receives data on at least a part of radio resources allocated to the first transceiver from a second transceiver.

Embodiments of the present invention are located in the field of mobile communication, in particular in the field of efficient radio resource management in mobile communication systems.

Future generations of cellular networks increasingly use Device-to-Device (D2D) communication in addition to the originally merely infrastructure-based communication. Central applications in this respect are found e.g. in the field of machine-to-machine (M2M) communication. These are often distinguished by connections on which only packets of smaller size may be transmitted (as compared to conventional data connections).

M2M communication is, for example, used for transmitting data between different terminal devices without a human interaction taking place. Applications in this field for example exist in logistics, e.g. warehousing, tracking of goods, etc. or in engineering, e.g. remote diagnostics and servicing. Additionally, development activities are known dealing with M2M communication in fields like telemedicine, energy management, e.g. Smart Metering/Smart Grid, mobility, e.g. E-mobility, Car-to-X, etc.

Conventional applications include, for example, stationary installations of M2M components, like e.g. in consumption meters, vending machines, in remote servicing of machines etc. Many of these M2M applications make use of communication via mobile radio which allows, apart from the necessity of permanent communication connections being omitted, to provide a communication link to otherwise non-reachable areas.

E.g., the current 4th Generation LTE mobile radio standard (Long Term Evolution) may not always efficiently use the available resources for typical M2M applications. One reason for this is the too coarse granularity of resource allocation within LTE. In the LTE standard a minimum allocation unit in the form of resource blocks is determined which currently comprises the length of one transmission time interval (TTI) or 1 ms in the time domain and/or 12 sub-carriers having an interval each of 15 kHz in the frequency domain (all in all 180 kHz). By this, a minimum amount of data is determined reserved by encoding, modulation, number of symbols, e.g. which is then also given for channel estimates, control information, etc. For normal applications, e.g. web browsing, FTP download, video streaming, this amount may usually be filled up such that an efficient data transmission results. In case of an M2M transmission, this may lead to part of the resources which may be allocated to an individual M2M user remaining unused as only part of the transmission is required. In the overall system this leads to a more unfavorable utilization of the resources and thus to a lower capacity utilization and consequently a lower efficiency of data transmission.

From the prior art methods are known which deal with the above mentioned problem. 3GPP (3rd Generation Partnership Project), “TR 36.881: Study on latency reduction techniques for LTE (Release 13)”, 2015, proposes a finer granularity of resource allocation in LTE. This allocation is conventionally done in every so-called TTI which currently corresponds to exactly one LTE sub-frame, i.e. takes exactly one millisecond. Instead of executing the distribution of the resources only in every LTE sub-frame, this might also be done in shorter intervals. Within the standardization within 3GPP currently a reduction/shortening of the TTI is discussed. In concrete terms here both halving the TTI to 0.5 milliseconds and also a reduction down to a length of an OFDM symbol (Orthogonal Frequency Division Multiplexing) of a length of 66.7 micro-seconds are discussed. This method is coupled with an increase of signaling information to be transmitted. Same are already comparatively high in systems today which may in practice already lead to capacity bottlenecks in the corresponding channels for exchanging signaling information (physical downlink/uplink control channel). In 3GPP the decrease of granularity of resource allocation to make transmission more efficient for small amounts of data and a decrease of the average access time for mobile terminal devices are discussed.

A further possibility is the allocation of the same resource block to different users, see M. Belleschi, G. Fodor, D. Della Penda, A. Pradini, M. Johansson and A. Abrardo,

“Benchmarking Practical RRM Algorithms for D2D Communications in LTE Advanced,” Wireless personal communications, pp. 883—910, 2015. In particular with greater distances of transmission paths interference between the transmissions is reduced. Thus, the occurring efficiency reduction may in part be balanced. A possible disadvantage of this method may be that when selecting transmission paths a relatively large spatial distance between the transmissions is required. In particular a simultaneous communication of users in close proximity may be difficult using this method. The authors are discussing a reuse of the same resources by spatially separated terminal devices.

Apart from that, in P. e. a. Xue, “Schemes Related to Resource Allocation, Discovery and Signaling in D2D Systems”. USA Patent US2015327315, Dec. 11, 2015, basic methods for allocating resources, for finding terminal devices and for signaling in D2D systems are discussed. Here, among others a D2D resource pool is described which is distributed across a Broadcast Channel (BCH) and then used for communication. However, also this approach uses a Physical Resource Block (PRB) as the smallest resource element. In document US2015327315 methods for in-coverage resource allocation scenarios and out-of-coverage resource allocation scenarios are discussed, e.g. by using a resource pool. Apart from that, methods for the discovery of D2D terminal devices and a method for transmission for resource allocation between D2D terminal devices (Scheduling Assignment (SA) message) are disclosed. The disclosure further proposes designating the resources to be used in the frequency-time domain within the SA message.

Reference WO 2015/113590 A1 discloses a concept for allocating radio resources within a group of mobile devices wherein a so-called “cluster head” takes over administrative tasks within the groups of mobile devices.

Reference US 2014/0369292 A1 describes a concept wherein a two-stage resource allocation method is used.

Document US 2015/0312952 A1 discloses a mechanism for direct communication between mobiles allocated to different providers.

Reference US 2014/0328329 proposes a pool based resource allocation mechanism for a base station.

Document US 2013/0223352 A1 describes a resource allocation mechanism for a direct communication between mobiles.

Reference US 2012/0300662 A1 discloses an allocation mechanism of radio resources for several cells and for a direct communication between mobiles.

Document WO 2015/113720 A1 proposes a time-based allocation concept for a direct communication between mobiles.

Reference US 2010/0227622 A1 deals with quality-of-service and the associated resource management.

Document US 2012/0201158 A1 proposes a utility metric for the coordination of radio resources in case of a direct communication between mobiles.

Reference WO 2009/138820A1 describes a concept for the coordination of radio resources in case of a direct communication between mobiles.

Document US 2010/0208673 A1 deals with direct communication between mobiles in a mobile communication system and using virtual resource blocks in radio resource allocation.

Reference US 2008/0192847 A1, in radio resource allocation for direct communication between mobiles of a mobile communication system, differentiates between local and distributed virtual resource blocks.

It is thus the object of the present invention to provide an improved concept for a resource allocation in particular in machine-to-machine communications in a mobile radio network.

This object is solved by any of the independent claims.

Embodiments are based on the finding that radio resources may also be used with reduced granularity and may be managed with little effort, for example when same may be directly transferred by mobile devices. Apart from that, embodiments are based on the finding that once radio resources have been allocated same may be passed on and thus be used simultaneously by several participants and/or users. Thus, embodiments may enable a (re-) use of unused radio resources with a granularity smaller than TTI, a transfer and/or passing on of radio resources by mobile terminal devices and a simultaneous use of radio resources by several mobile terminal devices (from the point of view of the eNB/base station). All in all, embodiments may enable an enhanced efficiency of radio resource utilization as non-required radio resources do not remain unused but may be passed on to other participants and be used by same for transferring own data. The re-use of resources is currently intended for LTE, for example, for complete resource blocks. Embodiments enable to pass on or re-use a use of resource blocks which were allocated to a user but were only used in part or not at all.

Embodiments provide a transceiver for providing information on non-required radio resources in a mobile communication system. The mobile communication system here includes the transceiver as a first transceiver and at least one second transceiver. The (first) transceiver includes a transceiver module for communicating in the mobile communication system and for obtaining information on a group of allocated radio resources, for example from a base station transceiver or generally from any other transceiver. The transceiver further includes a control module for controlling the transceiver module, the control module being configured to determine information on an actual need of allocated radio resources for transmitting payload data of the first transceiver in the mobile communication system. The control module is further configured to determine, from the information on an actual need of allocated radio resources, information on radio resources not required for the transfer of the payload data, and to transfer information on the non-required radio resources to the second transceiver. Embodiments may thus enable providing information on non-required radio resources and thus a more efficient use of the radio resources.

Embodiments further provide a further transceiver for a communication in a mobile communication system. The mobile communication system at least includes the above described transceiver as a first transceiver and the further transceiver as the second transceiver. The second transceiver includes a transceiver module for communicating in the mobile communication system and for determining information on non-required radio resources from the first transceiver in the mobile communication system. The second transceiver further includes a control module for controlling the transceiver module. The control module is configured, based on the information on the non-required radio resources of the first transceiver, to transmit payload data using the non-required radio resources of the first transceiver in the mobile communication system. Embodiments may thus enable the allocation of non-required radio resources by another transceiver and facilitate a more efficient radio resource utilization.

Embodiments further provide a base station transceiver for a communication with a first transceiver and a second transceiver in a mobile communication system. The base station transceiver includes a transceiver module for a communication in the mobile communication system. The base station transceiver further includes a control module for controlling the transceiver. The control module is configured to manage radio resources, allocate a group of radio resources to the first transceiver and to receive payload data on at least one subset of the radio resources from the second transceiver. In this respect, embodiments provide a base station transceiver which may receive payload data on radio resources from a transceiver although at least part of these radio resources has been allocated to another transceiver. Embodiments of base station transceivers may thus also contribute to a more efficient radio transmission.

Embodiments provide a first transceiver for example receiving radio resources from a base station transceiver which are in part not required. The non-required radio resources may be passed on to a second transceiver which in turn uses same, for example, to again pass on payload data to the base station transceiver.

In some embodiments, the control module of the first transceiver may further be configured to determine information on second transceivers located in its surroundings and suitable for a transfer of the allocated radio resources before the transmission of the payload data. In so far, the second transceiver may be selected from several ones and the first transceiver may, for example, detect or find second transceivers located nearby autonomously. Embodiments may thus keep a signaling effort low as, for example, the base station in this selection process has no signaling effort.

The group of allocated radio resources may correspond to a radio resource block allocated by a base station transceiver of the mobile communication system. The radio resource block may, for example, be a smallest radio resource amount that may be allocated by the base station transceiver, e.g. one or several PRBs in an LTE system, depending on which smallest unity is practical or still addressable. The non-required radio resources may be a subset of the group of radio resources, e.g. a sub-group of the symbols or OFDM symbols in a PRB in an LTE system. In further embodiments, the control module of the first transceiver may be configured to transfer the information on the non-required radio resources to the second transceiver using at least part of the allocated groups of radio resources. Thus, a possibility of signaling is possible without allocation by or request at the base station. The control module of the first transceiver may further be configured to transfer the payload data to another transceiver using the same or a different part of the group of allocated radio resources. In this respect, a signaling to the second transceiver may be included in a communication to another transceiver which may enable a fast signaling involving little effort.

In further embodiments, the control module of the second transceiver, which the resources not required by the first transceiver are allocated to, may be configured to transfer own payload data of the second transceiver. In some embodiments the second transceiver may further be configured as a relay transceiver between a base station transceiver and a further transceiver of the mobile communication system. The control module of the second transceiver may then be configured to allocate at least a part of the non-required radio resources to the further transceiver and transfer payload data of the further transceiver utilizing the non-required radio resources. Embodiments may thus also enable an efficient radio resource utilization in a relay scenario.

In some further embodiments the control module of the second transceiver may also be configured to monitor a communication between the first transceiver and another transceiver. Obtaining information on the non-required radio resources may then correspond to detecting a transmission end of a data transmission between the first and the other transceiver. In so far, some embodiments may completely prevent and/or substantially reduce a signaling between the first and the second transceiver by monitoring the signals of the first transceiver which are intended for a different transceiver by the second transceiver.

In some further embodiments, the control module of the base station transceiver may be configured to provide the group of radio resources to the first transceiver for a direct communication with another transceiver. In so far, embodiments may enable a more efficient resource utilization in D2D scenarios.

Embodiments also provide a method for a transceiver for providing information on non-required radio resources in a mobile communication system. The mobile communication system includes the transceiver as a first transceiver and at least one second transceiver. The method includes communicating in the mobile communication system and receiving information on a group of allocated radio resources. The method further comprises determining information on an actual need of allocated radio resources for transmitting payload data of the first transceiver in the mobile communication system and determining information on radio resources not required for the transfer of the payload from the information on the actual need. The method also comprises transferring information on the non-required radio resources to the second transceiver.

Embodiments provide a further method for a transceiver for a communication in a mobile communication system, the mobile communication system comprising at least one further transceiver as a first transceiver and the transceiver as the second transceiver. The method includes communicating in the mobile communication system and determining information on non-required radio resources from the first transceiver in the mobile communication system. The method further comprises transmitting payload data utilizing the non-required radio resources of the first transceiver in the mobile communication system based on the information on the non-required radio resources of the first transceiver.

Embodiments further provide a method for a base station transceiver for a communication with a first transceiver and a second transceiver in a mobile communication system. The method includes communicating in the mobile communication system and managing radio resources. The method further includes allocating a group of radio resources to the first transceiver and receiving payload data from the second transceiver via at least a sub-group of radio resources.

A further embodiment is a computer program for executing at least one of the above described methods when the computer program is executed on a computer, a processor, or a programmable hardware component. A further embodiment is a digital storage medium which is machine or computer readable and comprises electronically readable control signals which may cooperate with a programmable hardware component so that one of the above described methods is executed.

In the following, further advantageous embodiments are explained in more detail with reference to the embodiments illustrated in the Figures to which embodiments are not restricted, however, and in which:

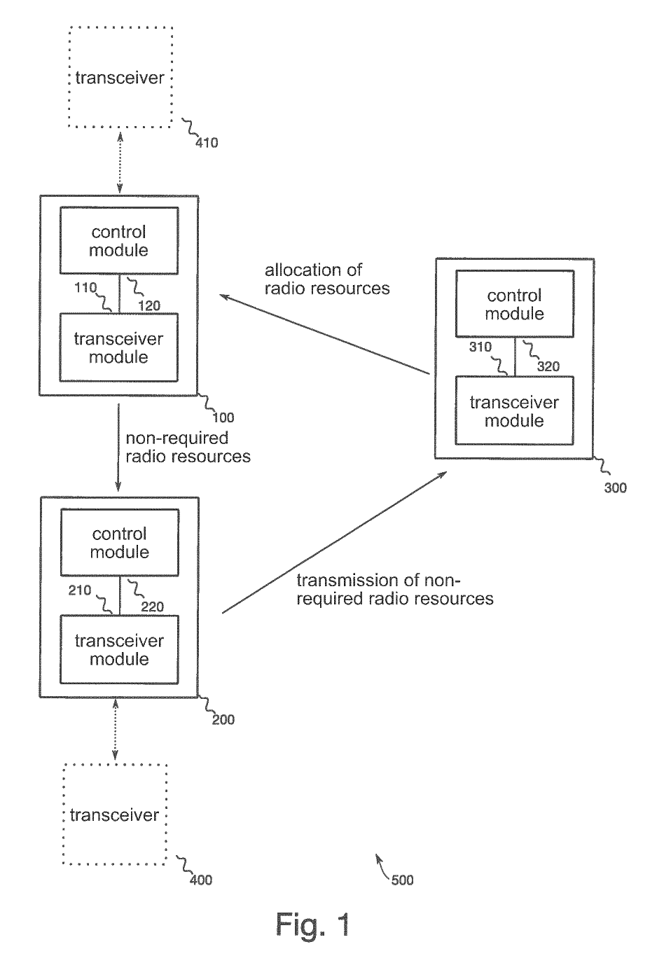

FIG. 1 shows embodiments of a first and second transceiver in a network scenario together with an embodiment of a base station transceiver;

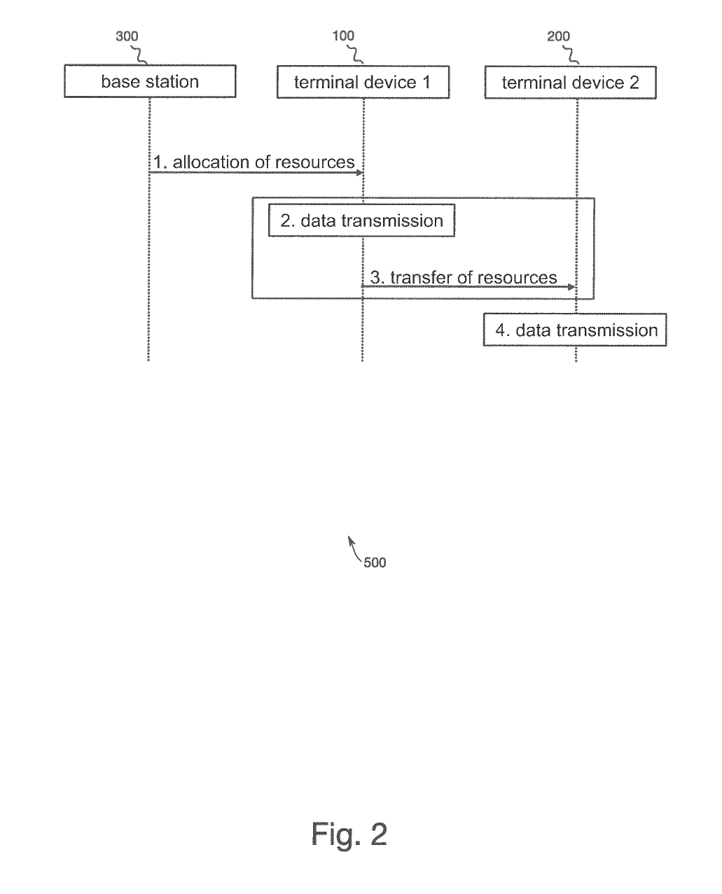

FIG. 2 shows a sequence of a signaling course in one embodiment;

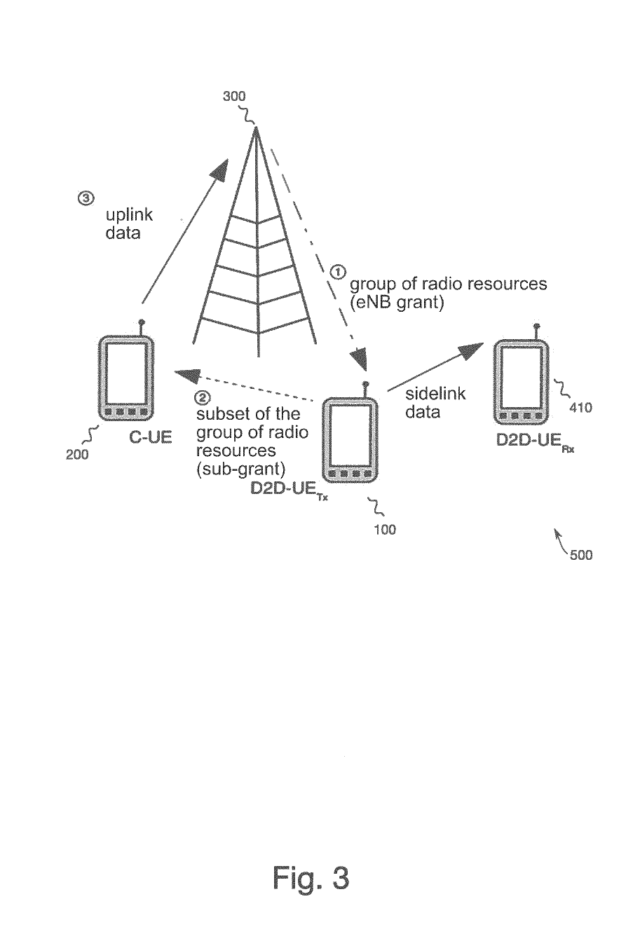

FIG. 3 shows further embodiments of a first and second transceiver in a further network scenario together with a further embodiment of a base station transceiver;

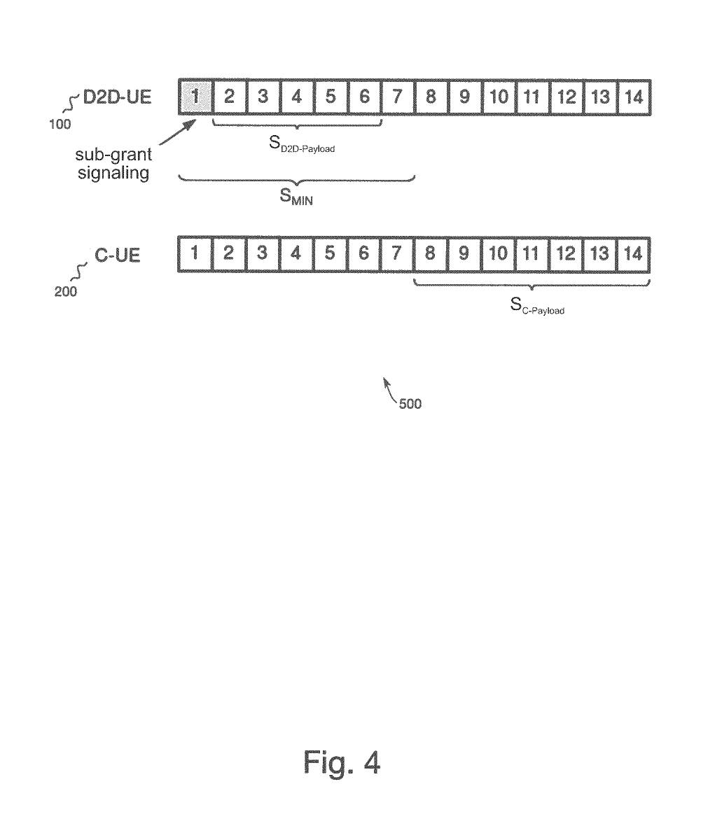

FIG. 4 shows a signaling scheme in an embodiment in an LTE system;

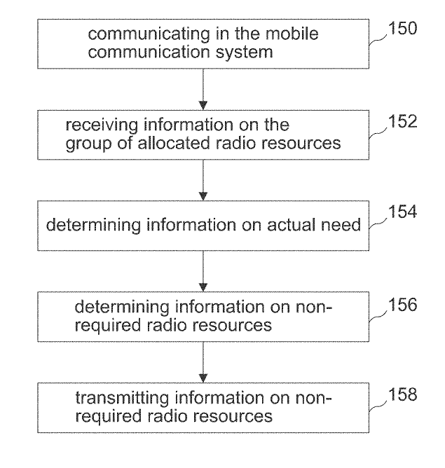

FIG. 5 shows a block diagram of a flow chart of an embodiment of a method for a transceiver;

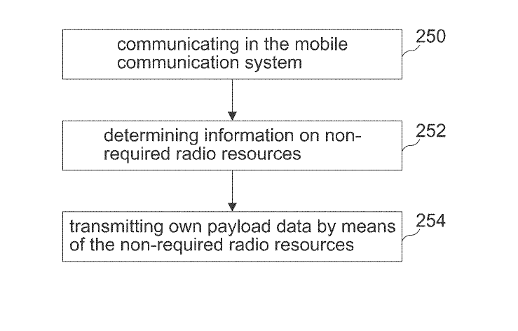

FIG. 6 shows a block diagram of a flow chart of an embodiment of a further method for a further transceiver; and

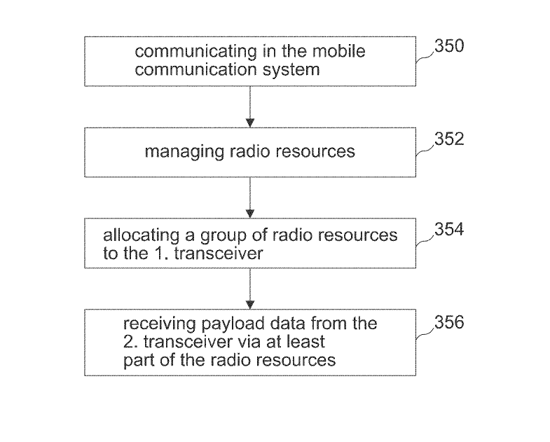

FIG. 7 shows a block diagram of a flow chart of an embodiment of a method for a base station transceiver.

Like numbers refer to like or similar components throughout the following description of the included figures, which merely show some exemplary embodiments. Moreover, summarizing reference signs will be used for components and objects which occur several times in one embodiment or in one Figure but are described at the same time with respect to one or several features. Components and objects described with like or summarizing reference signs may be implemented alike or also differently, if applicable, with respect to one or more or all the features, e.g. their dimensioning, unless explicitly or implicitly stated otherwise in the description. Optional components are illustrated in the Figures by dashed lines or arrows.

Although embodiments may be modified and changed in different ways, embodiments are illustrated as examples in the Figures and are described herein in detail. It is to be noted, however, that it is not intended to restrict embodiments to the respectively disclosed forms but that embodiments rather ought to cover any functional and/or structural modifications, equivalents and alternatives which are within the scope of the invention. Same reference numerals designate same or similar elements throughout the complete description of the figures.

It is noted, that an element which is referred to as being “connected” or “coupled” or “interconnected” to another element, may be directly connected, coupled or interconnected to the other element or that intervening elements may be present. If an element is referred to as being “directly connected”, “directly coupled” or “directly interconnected” to another element, no intervening elements are present. Other terms used to describe a relationship between elements ought to be interpreted likewise (e.g. “between” versus “directly between”, “adjacent” versus “directly adjacent”, etc.).

The terminology used herein only serves for the description of specific embodiments and should not limit the embodiments. As used herein, the singular forms such as “a,” “an” and “the” also include the plural forms, as long as the context does not indicate otherwise. It will be further understood that the terms e.g. “contain”, “containing”, “comprise,” “comprising,” “include” and/or “including,” as used herein, specify the presence of the stated features, integers, steps, operations, elements and/or components, but do not preclude the presence or addition of one and/or more other features, integers, steps, operations, elements, components and/or any group thereof

Unless otherwise defined, all terms (including technical and scientific terms) are used herein in their ordinary meaning of the art to which the examples belong and given to same by a person of ordinary skill in the art. It is further clarified that terms like e.g. those defined ion generally used dictionaries are to be interpreted to have the meaning consistent with the meaning in the context of relevant technology and will not be interpreted in an idealized or overly formal sense unless expressly defined otherwise herein.

FIG. 1 shows embodiments of a first and second transceiver 100, 200 in a network scenario together with an embodiment of a base station transceiver 300. FIG. 1 shows the transceiver 100 configured to provide information on non-required radio resources in a mobile communication system 500. The mobile communication system 500 includes the transceiver 100 as a first transceiver 100 and at least the second transceiver 200. In the scenario illustrated in FIG. 1, the mobile communication system 500 optionally additionally includes the base station transceiver 300 and further or other transceivers 400, 410.

Embodiments may thus provide transceivers/mobile radio devices 100, 200, 300 configured for communicating data via a mobile radio system 500 among one another and/or with a server or computer or another communication partner which may, for example, be reached via the internet and/or the World Wide Web (www) or another network. The mobile radio system/communication system 500 may, for example, correspond to one of the mobile radio systems which are standardized by corresponding standardization boards like e.g. the 3GPP group. For example, the same include the Global System for Mobile Communications (GSM), Enhanced Data Rates for GSM Evolution (EDGE), GSM EDGE Radio Access Network (GERAN), the Universal Terrestrial Radio Access Network (UTRAN) or the Evolved UTRAN (E-UTRAN), like e.g. the Universal Mobile Telecommunication System (UMTS), Long Term Evolution (LTE) or LTE-Advanced (LTE-A), or also mobile radio systems of different standards like e.g. the

Worldwide Interoperability for Microwave Access (WIMAX), IEEE802.16 or Wireless Local Area Network (WLAN), IEEE802.11, or in general any system based on a Time Division Multiple Access (TDMA), Frequency Division Multiple Access (FDMA), Code Division Multiple Access (CDMA), Orthogonal Frequency Division Multiple Access (OFDMA) or any other technology and/or multiple access method. In the following, the terms mobile radio system, mobile communication system and mobile radio network are used synonymously.

In so far, radio resources described herein relate to one or several elements of the group of frequency resources, e.g. carriers or sub-carriers, bands or sub-bands, etc., time resources, e.g. time slots, slots, radio frames, frames, sub-frames, symbols, etc., code resources, e.g. orthogonal codes, e.g. channelization codes, scrambling codes, orthogonal variable spreading factor codes, etc., or spatial resources, like e.g. spatial channels, spatial sub channels, beams, antennae, etc. For example, a PRB used in the LTE may represent a group of radio resources.

A base station transceiver 300 or a base station (these terms may be used equivalently) may be configured to communicate with one or more active mobile radio devices and to communicate in or adjacent to a supply or coverage area of another base station transceiver or a base station, e.g. as a macro cell base station or a small cell base station. Thus, embodiments may include a mobile communication system 500 with one or more mobile radio terminal devices and one or several base stations 300, wherein the base station transceivers 300 may provide macro cells or small cells, e.g. pico, metro or femto cells. A mobile transceiver or mobile radio terminal device may correspond to a smartphone, mobile phone, a user device, a radio device, a mobile, a mobile station, a laptop, a notebook, a personal computer (PC), a personal digital assistant (PDA), a stick or adapter of a universal serial bus (USB), a mobile radio modem, a car, etc. A mobile transceiver may also be called user equipment (UE) or mobile according to 3GPP terminology.

A base station transceiver 300 or a base station may be located in a stationary or at least firmly connected part of the network or system from the point of view of a mobile radio terminal device. A base station transceiver or a base station may also correspond to a remote radio head, a relay station, a transmission point, an access point, a radio device, a macro cell, a small cell, a micro cell, a femto cell, a metro cell, etc. A base station 300 or a base station transceiver is thus regarded as a logical concept of a node/a unit for providing a radio carrier or radio connections via the radio interface via which a terminal device/mobile transceiver gets access to a mobile radio network.

A base station or base station transceiver may represent a wireless interface for mobile radio terminal devices to a wired network. The used radio signals may be 3GPP-standardized radio signals or in general radio signal according to one or more of the above mentioned systems. Thus, a base station or base station transceiver may correspond to a NodeB, an eNodeB, a Base Transceiver Station (BTS), an access point, a Remote Radio Head, a transmission point, a relay station, etc. which are divided into further functional units.

A mobile radio terminal device or a mobile transceiver may be allocated to a base station or cell or be registered at the same. The term cell refers to a coverage area of radio services provided by a base station, e.g. a NodeB (NB), an eNodeB (eNB), a Remote Radio Head, a transmission point, a relay station, etc. A base station may provide one or more cells on one or more carrier frequencies. In some embodiments a cell may also correspond to a sector. E.g., sectors may be formed with sector antennas which are configured for covering an angular section around an antenna location. In some embodiments a base station may, for example, be configured for operating three or six cells or sectors (e.g. 120° in case of three cells and 60° in case of six cells). A base station may include several sector antennas. In the following, the terms cell and base station may also be used interchangeably. Apart from that, stationary and mobile base stations may be distinguished, wherein mobile base stations may also function as mobile relay stations.

The transceiver 100 illustrated in FIG. 1 may thus in various embodiments also be a base station transceiver, a relay transceiver or a mobile transceiver. The transceiver 100 includes a transceiver module 110 for communicating in the mobile communication system 500 and receiving information on a group of allocated radio resources. In embodiments, the transceiver module 100 may contain typical transmitter and/or receiver components, and the same also applies to the transceiver modules 210 and 310 explained in more detail in the following. Among the same there may, for example, be one or more antennas, one or more filters, one or more mixers, one or more amplifiers, one or more diplexers, one or more duplexers, etc. At presence, the transceiver modules 110, 210, 310 enable the communication in the mobile communication system 500.

As shown in FIG. 1, the transceiver 100 comprises a control module 120, which is coupled to the at transceiver module 110. In embodiments, the control module 120 may correspond to any controller or processor or to a programmable hardware component. For example, the control module 120 may also be realized as software which is programmed for a corresponding hardware component. In so far, the control module 120 may be implemented as a programmable hardware with an accordingly adapted software. Here, any processors may be used, like digital signal processors (DSPs). Embodiments are not restricted to a certain type of processor here. Any processors or also several processors are possible for implementing the control module 120. What was said about the implementation of the control module 120 also applies to the implementation of the control modules 220 and 320 which are described in more detail in the following.

The control module 120 is configured to control the transceiver module 110. The control module 120 is further adapted to determine information on an actual need of allocated radio resources for transmitting payload data of the first transceiver 100 in the mobile communication system 500. From the information on the actual need of allocated radio resources, the control module 120 may further determine information on radio resources not required for the transfer of the payload data and transfer information on the non-required radio resources to the second transceiver 200.

The second transceiver 200 in FIG. 1 is also configured for a communication in the mobile communication system 500. The second transceiver 200 includes a transceiver module 210 coupled to a control module 220. Regarding the implementation of these components reference is made to the description of the transceiver module 110 and the control module 120 above. The transceiver module 210 of the second transceiver 200 is configured for a communication in the mobile communication system 500 and for determining information on non-required radio resources of the first transceiver 100 in the mobile communication system 500. The control module 220 is adapted to control the transceiver module 210. The control module 220 is further configured, based on the information on the non-required radio resources of the first transceiver 100, to transmit payload data using the non-required radio resources of the first transceiver 100 in the mobile communication system 500. FIG. 1 illustrates this transmission to the base station transceiver 300, in other embodiments the transmission may also be directed to other transceivers, for example to the further transceivers 400 illustrated in FIG. 1 as being optional.

Finally, FIG. 1 further illustrates an embodiment of a base station transceiver 300. The base station transceiver 300 is configured for a communication with the first transceiver 100 and the second transceiver 200 in the mobile communication system 500. The base station transceiver 300 includes a transceiver module 310 and a control module 320 coupled to the same which may be implemented for the transceiver module 110 and the control module 120 according to the description above. The transceiver module 310 is adapted for a communication in the mobile communication system 500. The control module 320 is adapted to control the transceiver module 310, to manage radio resources and to allocate a group of radio resources to the first transceiver 100. The control module is further configured to receive payload data on at least one sub-group of the radio resources from the second transceiver 200.

A central idea of embodiments is passing on unused radio resources to increase the efficiency of the communication system 500. Passing on resources may be executed in two steps in one embodiment. First, an allocation of the resources to a mobile terminal device, e.g. a transceiver 100, may be executed by the base station 300. In a second step, the non-required part of the resources is passed on by the terminal device or the transceiver 100 itself to a second terminal device 200. FIG. 2 shows a sequence or flow chart of a signaling course in one embodiment.

FIG. 2 shows, in conformity with the embodiment of FIG. 1, the base station transceiver 300 on the left, the transceiver 100 implemented as a terminal device in the middle (also “terminal device 1”) and the transceiver 200 on the right, which is also implemented as a terminal device (also “terminal device 2”). FIG. 2 shows a possible realization of an embodiment of a method. In a first act, resource allocation is executed by the base station 300, e.g. the allocation of a group of radio resources. The base station 300 allocates the radio resources to a mobile terminal device 100 via the corresponding mechanisms of the system 500. In a second act data transfer is executed by the transceiver 100, “terminal device 1”. The transceiver 100, “terminal device 1” transfers and/or transmits its own payload data. In a third act the non-used resources are passed on to the transceiver 200, “terminal device 2”. In combination with the data transmission, in act 2 the non-used resources are passed on to the transceiver 200, “terminal device 2”. The selection of a suitable terminal device for transfer may be done by the original resource receiver (transceiver 100, terminal device 1), by the receiver of the transferred resources (transceiver 200, terminal device 2) or supported by the base station 300. Apart from passing on resources to terminal devices, same may also be passed on to subordinate base stations (e.g. femto cell, relay station or home eNB, implementations of the first and/or second transceiver 100, 200). In a fourth act data transfer may then be executed by the second transceiver 200, “terminal device 2”. The second transceiver 200 (terminal device 2) transfers its own payload data using the radio resources passed on to same.

FIG. 3 shows further embodiments of a first and second transceiver 100, 200 in a further network scenario together with an embodiment of a further base station transceiver 300. FIG. 3 shows a mobile communication system 500 with a first transceiver 100 implemented here as a terminal device, a second transceiver 200 also implemented here as a terminal device and another transceiver 410 also implemented as a terminal device. The mobile communication system 500 further illustrates an embodiment 300 of a base station transceiver 300. In the following, the application of the embodiments in an LTE system is described and reference is made to the efficiency improvement of the mobile radio transmission.

FIG. 3 shows a typical situation in a future LTE transmission system. In this scenario, the resources of a D2D transmission between a D2D-UETx, the transceiver 100, and a D2D-UERx, the other transceiver 410, ought to be passed on as sidelink data from another transmission between a C-UE (cellular UE), the second transceiver 200, and the base station 300 (uplink data).

In a preparational step (not illustrated in FIG. 3) the transmitting mobile radio station (D2D-UETx) 100 determines the neighboring participants, e.g. C-UE 200, which are nearby. In this embodiment, the control module of 120 the first transceiver 100 is further configured to determine information on second transceivers 200 located in its surroundings and suitable for transfer of the allocated radio resources before the transmission of the payload data. The embodiment of a method consequently is as follows:

In a first act (encircled 1 in FIG. 3) the base station transceiver 300, here an eNB (eNodeB), provides the required resources for D2D communication between D2D-UETx 100 and D2D-UERx 410 in the form of an eNB grant to the participating mobile radio stations, here the transceivers 100, 410. In this embodiment, the control module 320 of the base station transceiver 300 is configured to provide the group of radio resources (eNB grant) to the first transceiver 100 for a direct communication with another transceiver 410. Apart from information on the used modulation and encoding methods, this information contains the allocated resource blocks which may be used for D2D transmission. For reducing the signaling overhead this may represent a permanent allocation.

In a second act (encircled 2 in FIG. 3) the transmitting D2D-UETx 100 for example determines during a D2D transmission that it does not require the complete resource block for transmission. It informs the previously selected neighbor participant (C-UE) 200 on the passed-on resource portions by using a sub-grant, i.e. a subset of the group of radio resources. In this embodiment, the group of allocated radio resources (eNB Grant) corresponds to a radio resource block, a PRB, allocated by the base station transceiver 300 of the mobile communication system 500, here LTE. The radio resource block here corresponds to a smallest radio resource amount that may be allocated by the base station transceiver 300. The non-required radio resources correspond to a subset of the group of radio resources (sub-grant).

It is to be noted here, that the smallest radio resource amount that may be allocated by the base station transceiver 300 is not exclusively given by the standard of the respective mobile communication system. For example, the smallest amount that may be allocated according to the specification of a standard depending on the system configuration or parametrization may not be addressable and the smallest amount of resources that may be allocated may thus correspond to the smallest addressable amount of radio resources. In some embodiments, the smallest amount of resources that may be allocated may be limited due to capacity bottlenecks for signaling the allocation. This may for example be the case in an LTE system with a bandwidth of 20 MHz (and thus all in all 100 PRBs). In this system, in each TTI theoretically 100 transceivers may transmit data simultaneously both in the uplink and also in the downlink. When utilizing a dynamic scheduling (resource allocation), in this respect also signaling information (scheduling grant) in the intended transmission channel (PDCCH, Physical Downlink Control Channel) ought to be transmitted in every TTI. As same is limited regarding its capacity and is not used exclusively for signaling access rights, only a certain number of scheduling grants may be transmitted per TTI and/or several PRB are allocated at once as the smallest amount of radio resources that may be allocated, e.g. 5 PRBs, which may then be passed on accordingly in embodiments.

The resource allocated by the eNB is consequently not necessarily the smallest amount of radio resources that may be allocated in the sense of a theoretically possible smallest granularity or in the sense of one given by a standard in order to then be transferred. It may also be the case that, for example, an eNB e.g. allocates 5 PRBs (e.g. as the PDCCH could not transport any further grants anyway) and that 4.5 PRB of those are passed on. In so far, the smallest amount of radio resources corresponds to the smallest amount of radio resources that may be allocated or distributed in practice.

In a third act (encircled 3 in FIG. 3) the selected participant C-UE 200 uses this resource allocation to e.g. transmit data to the eNodeB 300 (uplink data). The transfer of the passed on resource may be done in different ways. One simple method is that the C-UE 200 autonomously monitors the allocated D2D resource (eNB grant) and the D2D data transmission (sidelink data). When the end of a D2D data transmission is determined, thus the C-UE 200 may use the remaining resources for its own transmission. The control module 220 of the second transceiver 200 is then configured to monitor a communication between the first transceiver 100 and another transceiver 410. Determining the information on the non-required radio resources then corresponds to detecting a transmission end of a data transmission between the first transceiver 100 and the other transceiver 410. Such embodiments may offer advantages in D2D transmissions wherein the D2D-UETx 100 may not determine the end of the data transmission in advance as it is the case with time-critical applications. On the other hand, here an increased effort in the C-UE 200 for detecting the end of the D2D transmission is required.

In other embodiments, in particular for less time-critical D2D transmissions, an explicit signaling of the sub-grant from the D2D-UETx 100 to the selected C-UE 200 may be executed. FIG. 4 shows a signaling scheme in an embodiment in an LTE system. In FIG. 4 a possible change of the data format of the D2D-UE 100 for transmitting the sub-grant is illustrated. FIG. 4 shows two transmission intervals (TTIs) of 14 consecutively numbered symbols each from left to right (2 “slots” of 7 OFDM symbols each) in the LTE system 500. In FIG. 4 above, the transmission interval for the transceiver 100, D2D-UE is illustrated, and at the bottom the transmission interval for the transceiver 200, C-UE. In the illustrated example part of the first OFDM symbol to be transmitted is used for signaling the sub-grant. The information to be transmitted e.g. contains an indicator, for example one or several bits, for the availability of the respective resource block for re-use, an identification number for the selected C-UE 200 and information on the OFDM symbol from which on the resource block may be reused. Thus, the identified C-UE 200 may transmit its payload S_{C-Payload} from the given symbol on (here exemplarily from the 8th symbol), after the transmission of the first transceiver 100, S_{D2D-Payload}, is completed. In FIG. 4, the seventh OFDM symbol is not occupied and forms a kind of guard interval to avoid interferences between the two transmissions. An interval of 7 OFDM symbols, S_{MIN}, results before the transmission of the second transceiver 200 starts.

In this embodiment, the control module 120 of the first transceiver 100, D2D-UE may be configured to transmit the information on the non-required radio resources to the second transceiver 200, C-UE, using at least part of the allocated group of radio resources (PRB). The control module 120 of the first transceiver 100 is further configured to transmit the payload data S_{D2D-Payload} to another transceiver 410, see FIG. 1, using the same or a different part of the group of allocated radio resources (here the first six OFDM symbols).

In addition to passing on resources from a D2D-UE 100 to a C-UE 200 described in this embodiment, the same may also be executed vice versa, i.e. from a C-UE 200 to a D2D-UE 100 or between two UEs of the same type. In further embodiments also a chain or a cascade is possible, in which subsets of the allocated radio resources are passed on across several stations, transceivers. As shown in FIG. 3, in some embodiments the control module 220 of the second transceiver 200 is configured to transmit own payload data of the second transceiver 200, in FIG. 3 to the base station transceiver 300. In some embodiments the second transceiver 200 may further be configured as a relay transceiver between a base station transceiver 300 and a further transceiver 400 of the mobile communication system 500. Such an embodiment is indicated in FIG. 1 by the further transceiver 400 illustrated in dashed lines. The control module 220 of the second transceiver 200 is then configured to allocate at least a part of the non-required radio resources to the further transceiver 400 and transfer payload data of the further transceiver 400 utilizing the non-required radio resources.

FIG. 5 shows a block diagram of a flow chart of an embodiment of a method for a first transceiver. The method for the first transceiver 100 provides information on non-required radio resources in a mobile communication system 500. The mobile communication system 500 includes the transceiver 100 as a first transceiver 100 and at least a second transceiver 200. The method includes communicating 150 in the mobile communication system 500 and receiving 152 information on a group of allocated radio resources. The method further comprises determining 154 information on an actual need of allocated radio resources for transmitting payload data of the first transceiver 100 in the mobile communication system 500, and determining 156 information on radio resources not required for the transfer of the payload from the information on the actual need. The method also comprises transferring 158 information on the non-required radio resources to the second transceiver 200.

FIG. 6 shows a block diagram of a flow chart of an embodiment of a further method for a second transceiver 200. The method for the second transceiver 200 enables a communication in a mobile communication system 500. The mobile communication system 500 again includes at least one further transceiver 100 as a first transceiver 100 and the second transceiver 200. The method includes communicating 250 in the mobile communication system 500 and determining 152 information on non-required radio resources from the first transceiver 100 in the mobile communication system 500. The method further comprises transmitting 254 payload data utilizing the non-required radio resources of the first transceiver 100 in the mobile communication system 500 based on the information on the non-required radio resources of the first transceiver 100.

FIG. 7 shows a block diagram of a flow chart of an embodiment of a method for a base station transceiver 300. The method for the base station transceiver 300 allows a communication with a first transceiver 100 and a second transceiver 200 in a mobile communication system 500. The method includes communicating 350 in the mobile communication system 500 and managing 352 radio resources. The method includes allocating 354 a group of radio resources to the first transceiver 100 and receiving 356 payload data from a second transceiver 200 via at least a sub-group of radio resources.

Further embodiments are computer programs having a program code for executing at least one of the above described methods when the program code is executed on a computer, a processor, or a programmable hardware component. A further embodiment is a digital storage medium which is machine or computer readable and comprises the electronically readable control signals which may cooperate with a programmable hardware component so that one of the above described methods is executed.

Embodiments for example provide an allocation of the decisions for radio resource allocation and/or utilization between base station and mobile terminal device. Here, the transmission of the complete radio resources or of parts of these radio resources may be enabled between mobile terminal devices. Some embodiments may combine the transmission of the user data and the transmission of the control information for resource utilization at the mobile terminal device. Combinations with other technologies are also conceivable, for example with TTI shortening for reducing latency or with frequency leap methods for increasing reliability. All in all, embodiments may enable an enhanced efficiency in data transmission in mobile communication networks as non-required radio resources do not simply remain unused but may be passed on to other participants and be used by same for transferring own data.

The features disclosed in the above description, the enclosed claims and the enclosed Figures may both individually and in any combination be of importance and implemented for realizing an embodiment in their various forms.

Although some aspects have been described in connection with an apparatus, it is clear that these aspects also illustrate a description of the corresponding method, where a block or a device of an apparatus is to be understood as a method step or a feature of a method step. Analogously, aspects described in the context of or as a method step also represent a description of a corresponding block or detail or feature of a corresponding apparatus.

Depending on certain implementation requirements, embodiments of the invention can be implemented in hardware or in software. The implementation can be performed using a digital storage medium, for example a floppy disk, a DVD, a Blue-Ray, a CD, a ROM, a PROM, an EPROM, an EEPROM or a FLASH memory, a hard disc or another magnetic or optical memory having electronically readable control signals stored thereon, which cooperate or are capable of cooperating with a programmable hardware component such that the respective method is performed.

A programmable hardware component may be formed by a processor, a Central Processing Unit (CPU), a Graphics Processing Unit (GPU), a computer, a computer system, an Application-Specific Integrated Circuit (ASIC), an Integrated Circuit (IC), a System on Chip (SOC), a programmable logics element or a Field Programmable Gate Array (FPGA) comprising a microprocessor.

Therefore, the digital storage medium may be machine or computer readable. Some embodiments include also a data carrier comprising electronically readable control signals which are capable of cooperating with a programmable computer system or a programmable hardware component such that one of the methods described herein is performed. One embodiment is thus a data carrier (or a digital storage medium or a computer readable medium) on which the program for executing of the methods described herein is stored.

Generally speaking, embodiments of the present invention may be implemented as a program, firmware, a computer program or a computer program product having a program code or as data, wherein the program code or the data is effective to execute one of the methods when the program is executed on a processor, or a programmable hardware component. The program code or the data may, for example, also be stored on a machine-readable carrier or data carrier. The program code or the data may among others be present as a source code, machine code or byte code or any other intermediate code.

A further embodiment is a data stream, a signal sequence or a sequence of signals which may represent the program for executing one of the methods described herein. The data stream, the signal sequence or the sequence of signals may for example be configured so as to be transferred via a data communication connection, for example via the internet or another network. Embodiments thus also are signal sequences representing data suitable for being transferred via a network or a data communication connection, the data representing the program.

A program according to one embodiment may implement one of the methods during its execution for example by reading out memory locations or writing one or several data into the same, whereby possibly switching processes or other processes in transistor structures, in amplifier structures or in other electrical, optical, magnetic or other members operating according to another functional principle are caused. Accordingly, by reading out a memory location, data, values, sensor values or other information is determined, detected or measured by a program. By reading out one or several memory locations, a program may detect, determine or measure magnitudes, values, measured quantities and other information and, by writing into one or several memory locations, cause, trigger or execute an action and control other devices, machines and components.

The above described embodiments are merely an illustration of the principles of the present invention. It is understood that modifications and variations of the arrangements and the details described herein will be apparent to others skilled in the art. It is the intent, therefore, that this invention is limited only by the scope of the impending patent claims and not by the specific details presented by way of description and explanation of the embodiments herein.

1. A transceiver for providing information on non-required radio resources in a mobile communication system, the mobile communication system comprising the transceiver as first transceiver and at least one second transceiver, comprising
a transceiver module configured to communicate in the mobile communication system and configured to receive information on a group of allocated radio resources; and
a control module configure to control the transceiver module, the control module being configured to
determine information on an actual need of allocated radio resources for transmitting payload data of the first transceiver in the mobile communication system,
determine, from the information on the actual need of allocated radio resources, information on radio resources not required for the transfer of the payload data, and
transfer information on the non-required radio resources to the second transceiver,
wherein the group of allocated radio resources corresponds to one radio resource block allocated by a base station transceiver of the mobile communication system,
wherein the radio resource block corresponds to a smallest amount of radio resources that may be allocated by the base station transceiver, and
wherein the non-required radio resources are a subset of the group of radio resources.

2. The transceiver according to claim 1, wherein the control module is further configured to determine information on second transceivers located in its surroundings and suitable for transfer of the allocated radio resources before the transmission of the payload data.

3. The transceiver according to claim 1, wherein the control module is configured to transfer the information on the non-required radio resources to the second transceiver using at least part of the allocated group of radio resources and wherein control module is configured to transfer the payload data to another transceiver using the same or a different part of the group of allocated radio resources.

4. A transceiver for communication in a mobile communication system, wherein the mobile communication system comprises at least one further transceiver as a first transceiver and the transceiver as a second transceiver, comprising
a transceiver module configured to communicate in the mobile communication system and configured to determine information on non-required radio resources of the first transceiver in the mobile communication system, and
a control module for controlling the transceiver module, the control module being configured, based on the information on the non-required radio resources of the first transceiver, to transmit payload data using the non-required radio resources of the first transceiver in the mobile communication system,
wherein the group of allocated radio resources corresponds to one radio resource block allocated by a base station transceiver of the mobile communication system,
wherein the radio resource block corresponds to a smallest amount of radio resources that may be allocated by the base station transceiver, and
wherein the non-required radio resources are a subset of the group of radio resources.

5. The transceiver according to claim 4, wherein the control module is configured to transmit own payload data of the second transceiver and/or
wherein the second transceiver is configured as a relay transceiver between a base station transceiver and a further transceiver of the mobile communication system and wherein the control module is configured to allocate at least a part of the non-required radio resources to the further transceiver and transfer payload data of the further transceiver utilizing the non-required radio resources.

6. The transceiver according to claim 4, wherein the control module is configured to monitor a communication between the first transceiver and another transceiver and wherein determining the information on the non-required radio resources corresponds to detecting a transmission end of a data transmission between the first and the other transceiver.

7. A base station transceiver for communication with a first transceiver and a second transceiver in a mobile communication system (500), comprising
a transceiver module configured to communicate in the mobile communication system, and
a control module configured to control the transceiver module, the control module being configured to
manage radio resources and allocate a group of radio resources to the first transceiver and to receive payload data on at least one subset of the radio resources from the second transceiver,
wherein the group of allocated radio resources corresponds to an allocated radio resource block,
wherein the radio resource block corresponds to a smallest amount of radio resources that may be allocated by the base station transceiver, and
wherein the sub-group is a non-required subset of the allocated radio resources passed on from the first transceiver to the second transceiver.

8. The base station transceiver according to claim 7, wherein the control module is configured to provide the group of radio resources to the first transceiver for a direct communication with another transceiver.

9. (canceled)

10. A method for a transceivers for a communication in a mobile communication system, wherein the mobile communication system comprises at least one further transceiver as a first transceiver and the transceiver as a second transceiver, comprising
communicating in the mobile communication system; and
determining information on non-required radio resources from the first transceiver in the mobile communication system;
transmitting payload data utilizing the non-required radio resources of the first transceiver in the mobile communication system based on the information on the non-required radio resources of the first transceiver,
wherein the group of allocated radio resources corresponds to one radio resource block allocated by a base station transceiver of the mobile communication system,
wherein the radio resource block corresponds to a smallest amount of radio resources that may be allocated by the base station transceiver, and
wherein the non-required radio resources are a subset of the group of radio resources.

11-12. (canceled)

13. A machine readable storage medium including machine readable instructions, that, when executed, implements the method of claim 9.
